(19) United States
(12) Patent Application Publication
(10) Pub. No.: US 2026/0195240 A1
(43) Pub. Date: Jul. 9, 2026

(54) SYSTEMS AND METHODS FOR OPTIMIZING TRACE TREE SIZE

(71) Applicant: ServiceNow, Inc., Santa Clara, CA (US)

(72) Inventors: Martin Hlucka, Chula Vista, CA (US); Patrick Hayes Gund, Chicago, IL (US); Bijay Khatri, San Diego, CA (US)

(21) Appl. No.: 19/012,088

(22) Filed: Jan. 7, 2025

(51) Int. Cl. G06F 11/362

(52) U.S. Cl. CPC G06F 11/3636

(57) ABSTRACT

A method includes receiving trace data indicative of a plurality of traces associated with a workflow, receiving an input to filter a portion of the trace data, filtering the trace data based on the input to generate filtered trace data, wherein the filtered trace data is indicative of a subset of the plurality of traces, and generating, based on the filtered trace data, a graphical representation that indicates a trace tree including the subset of the plurality of traces.

### TECHNICAL FIELD

The present disclosure relates generally to displaying trace trees of traces obtained during execution of a workflow such that the trace tree can be displayed on a graphical user interface (GUI) while maintaining context of traces in the trace tree.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Information technology departments utilize workflows to execute repeatable sequences of tasks. Each workflow may include tens, hundreds, or thousands of pieces of internal process flow information logged as traces between various components used to implement the workflow. Traces can nest inside other traces, resulting in large, complex trace trees that may include thousands of traces spread across many branches of traces. Diagnostics may be difficult to conduct due to the complexity of the trace tree and the large number of traces. The trace tree may have hundreds or thousands of traces which may not fit on a Graphical User Interface (GUI) and may be difficult to parse when troubleshooting. Further, the context of the problem trace (e.g., the traces preceding and/or proceeding a particular trace) may be relevant to understanding the particular trace. Accordingly, new techniques for displaying trace trees while maintaining relevant trace context is needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving trace data indicative of a plurality of traces associated with a workflow. The method also includes receiving an input to filter a portion of the trace data. The method includes filtering the trace data based on the input to obtain filtered trace data. The filtered trace data is indicative of a subset of the plurality of traces. The method includes generating, based on the filtered trace data, a graphical representation that indicates a trace tree including the subset of the plurality of traces.

In another embodiment, a system includes processing circuitry. The system further includes a memory, accessible by the processing circuitry, and storing instructions that, when executed by the processing circuitry, cause the processing circuitry to implement a client instance. The system or a different processor-based system is configured to receive, via the client instance, trace data indicative of a plurality of traces associated with a workflow. The system or the different processor-based system is configured receive, via the client instance, an input to filter a portion of the trace data. Further, the system or the different processor-based system is configured to filter the trace data based on the input to obtain filtered trace data. The filtered trace data is indicative of a subset of the plurality of traces. The system or the different processor-based system is configured to generate for display, based on the filtered trace data, a graphical representation that indicates a trace tree including the subset of the plurality of traces.

In a further embodiment, a non-transitory, computer readable medium includes instructions that, when executed by processing circuitry, cause the processing circuitry to receive trace data indicative of a plurality of traces associated with a workflow. The processing circuitry further receives an input to filter a portion of the trace data. The processing circuitry filters the trace data based on the input to obtain filtered trace data. The filtered trace data is indicative of a subset of the plurality of traces. The processing circuitry generates based on the filtered trace data, a graphical representation that indicates a trace tree including the subset of the plurality of traces.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 is a flowchart of a process for generating a trace tree, in accordance with aspects of the present disclosure;

FIG. 6 is a flowchart of a process for displaying the trace tree obtained in FIG. 5, in accordance with aspects of the present disclosure;

FIG. 7 is a screenshot of a Graphical User Interface (GUI), accessible via a browser, that lists trace logs, in accordance with aspects of the present disclosure;

FIG. 8 is a screenshot of a GUI displaying the trace tree obtained in FIG. 5, in accordance with aspects of the present disclosure;

FIG. 9 is a screenshot of the GUI of FIG. 8, illustrating the front-to-back end nature of the trace tree, in accordance with aspects of the present disclosure;

FIG. 10 is a screenshot of a pop-up window on the GUI of FIGS. 8 and 9, that illustrates options for filtering the trace tree, in accordance with aspects of the present disclosure;

FIG. 11 is a screenshot of a GUI that illustrates viewable attributes of the trace tree, in accordance with aspects of the present disclosure;

FIG. 12 is a screenshot of the GUI of FIGS. 8-10 that illustrates the trace tree in a partially expanded state before filtering, in accordance with aspects of the present disclosure; and

FIG. 13 is a screenshot of the GUI of FIGS. 8-10 and 12 that illustrates the trace tree in a filtered state, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”,” real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

Information technology departments utilize workflows to execute repeatable sequences of tasks. Each workflow may include tens, hundreds, or thousands of pieces of internal process flow information logged as “traces” between various components used to implement the workflow. As used herein, a “trace” may be understood to be the process of recording information about the flow of commands or requests of an application or system. Traces can nest inside other traces, resulting in large, complex trace trees that may include thousands of traces spread across many branches of traces. Diagnostics may be difficult to conduct due to the complexity of the trace tree and the large number of traces. Indeed, locating the problem trace may be unnecessarily time consuming and difficult to achieve because the trace tree may have hundreds or thousands of traces which may not be meaningfully displayed on a Graphical User Interface (GUI) in a manner suitable for review. Further, the context of the problem trace (e.g., the traces preceding and/or proceeding a particular trace) may be relevant to understanding the particular trace. Accordingly, new techniques for displaying trace trees while maintaining relevant trace context is needed.

Various embodiments disclosed herein are directed to generating a UI indicating trace trees of traces obtained during execution of a workflow such that the trace tree can be displayed on a graphical user interface (GUI) while maintaining context of traces in the trace tree. For example, if a workflow has a problem with the back-end development, the algorithm may filter the trace tree to show only back-end traces. These traces may feature some context to assist with understanding the trace causing the workflow issue, such as traces that precede or proceed back-end traces. Further, the algorithm may bypass context determined to be irrelevant (e.g., based on filter settings, display settings, etc.). Conversely, if a workflow has a problem with the front-end development, the algorithm may filter the trace tree to show only front-end traces. Alternatively, the algorithm may prune the trace tree to generally simplify the trace tree to allow the GUI to display the trace tree more efficiently. By removing the irrelevant sections of the trace-tree, the sections of the trace tree that are relevant or otherwise useful for understanding the workflow issue may fit better on the GUI and make determining any issues with the workflow less tedious than when the entire trace tree is displayed on the GUI. The implementation routines discussed herein may capture the hierarchies (e.g., nests) of the traces in the trace tree. Further, such routines may mark the start and end time of the traces to calculate the duration of the traces. As such, the system may more efficiently utilize resources and computing power by reducing the amount of interaction the user has with the system to convey the same amount of information. For example, the system utilizes less computational resources by generating a graphical representation of a pruned trace tree that does not include irrelevant trace information, resulting in reduced user interaction with the graphical representation. The system also reduces system noise by limiting the amount of unnecessary clicking and unhelpful or incomplete summarization.

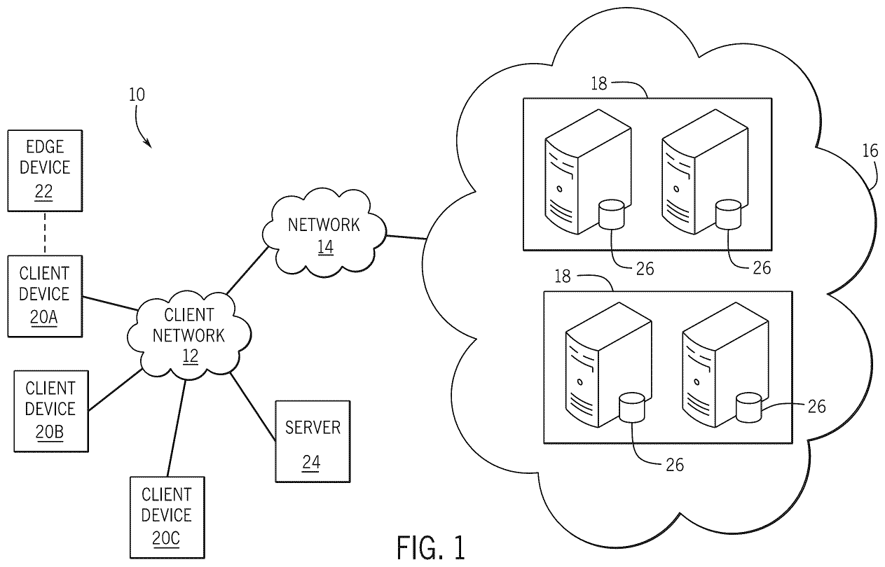

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

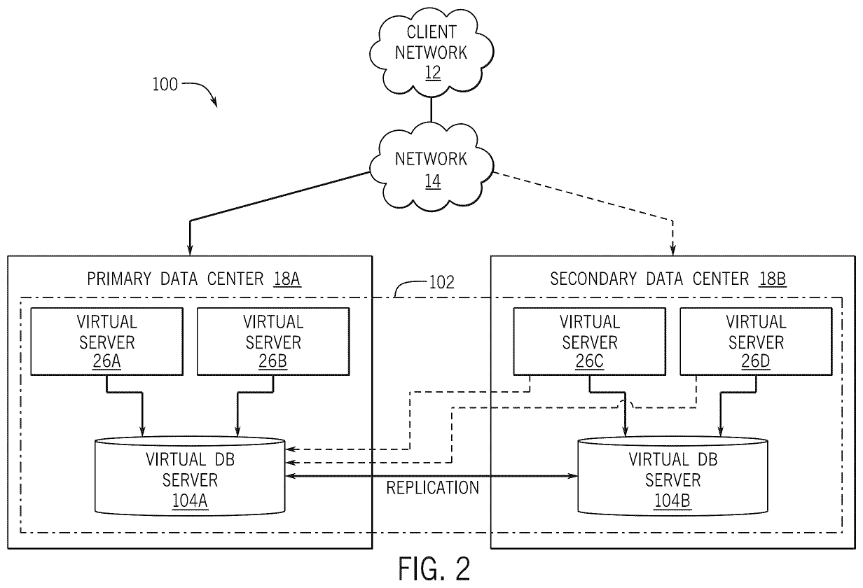

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

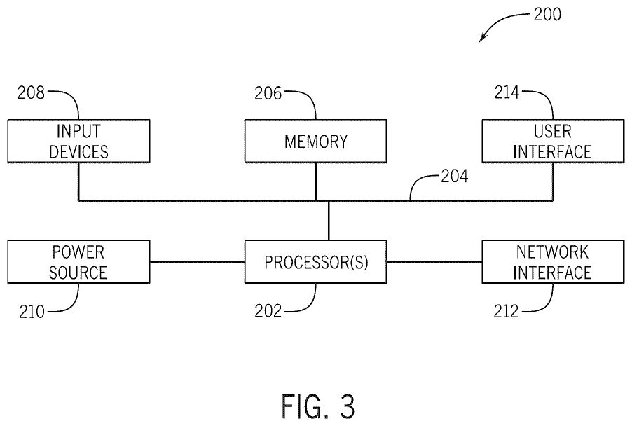

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

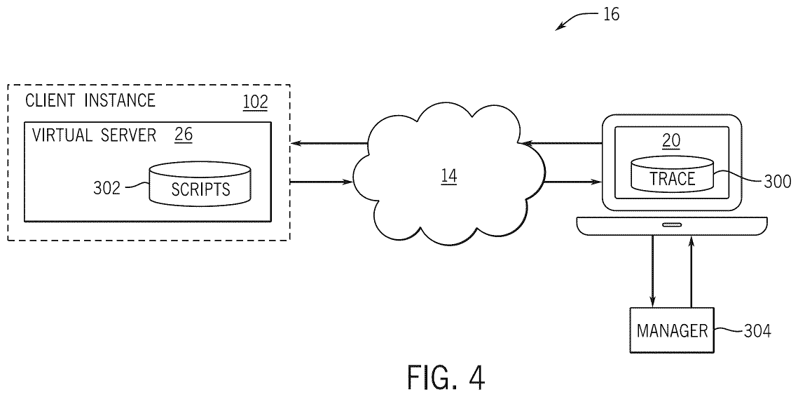

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

When web pages are accessed via the browser, logic defining various characteristics of the web page may be set forth in scripts that are retrieved from the document object model (DOM) of the web page when the web page is loaded and then executed and/or applied by the client device 20 via the browser. Within or accessible to the client device 20 may be a database 300. The database 300 may store traces associated with a workflow. These traces in the database 300 may be managed by a database manager 304. As shown in FIG. 4, in some embodiments, the database manager 304 may be external to the client device 20. However, in other embodiments, the database manager 304 may run on the client device 304 or in the client instance 102. The database manager 304 may determine what traces to keep in the database 300 and may determine what traces to display on the client device 20. Accordingly, logic may be run by the client device 20 to determine available options for parameters by which the database manager 304 may maintain, dispose of, or display traces on the client device 20.

Logic may be stored in scripts in a scripts database 302 (which may the same or different from the virtual database servers 104A, 104B shown in FIG. 2) on the server 26 side, either within or accessible by the virtual server 26 and/or the client instance 102. Specifically, as is described in more detail below, when a request to retrieve and filter trace data associated with a workflow is received as an input, the client instance 102 identifies the script(s) and retrieves the script(s) from the scripts database 302. The client instance 102 executes the retrieved script(s). Execution of the script results in data being generated and filtered based on user input, which is transmitted to the client device 20 for display. As the client device 20 receives inputs modifying, filtering, and/or manipulating a trace tree, the client device 20 provides the inputs to the client instance 102, which modifies the trace tree, and transmits the modified trace tree to the client device 20 for display.

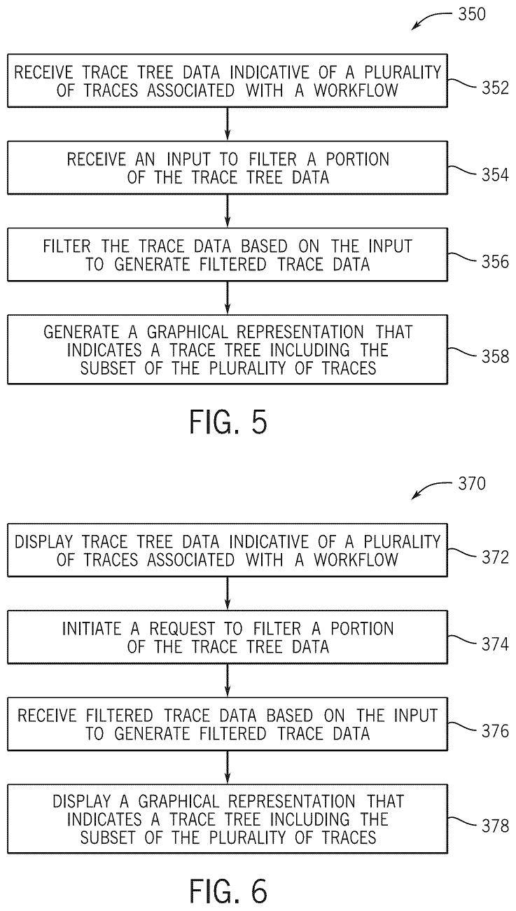

FIG. 5 is a flowchart of a process 350 of generating a trace tree from the client instance perspective 350 (e.g., the perspective of one or more hardware or virtual servers implementing a client instance at a data center or comparable site or of one or more application servers running in such an environment), and FIG. 6 is a flowchart of a process of displaying the obtained trace tree from the perspective of the client device 370. At block 352, the client instance 102 may receive trace tree data indicative of a plurality of traces associated with a workflow. For example, when a workflow is performed, multiple devices and/or components of devices may coordinate to perform one or more steps of the workflow. The devices and/or components may be disposed on the front end (e.g., client device), on the back end (e.g., server/instance), or in between. Traces are obtained when the devices communicate with one another or otherwise transmit data across the network. Trace data refers to data associated with the traces, such as what devices transmitted and/or received data, timestamps of communication, the size of data being transmitted, characteristics of the data being transmitted, IP addresses, MAC addresses, protocols being used, etc. Trace data from multiple traces associated with a workflow may be combined into a trace tree. The trace tree data associated with a workflow may be stored in the database 300. Upon request by the client instance 102, the database 300 may send the trace tree data to the client instance 102 (e.g., for storage in a database hosted by the instance or accessible to the instance). From the perspective of the client device 20, at block 372, the client device 20 may display trace tree data indicative of a plurality of traces associated with a workflow. When the client device 20 displays the trace tree data on the GUI, the user may view and interact with the trace tree data. The client device 20 may utilize the trace tree data received by the client instance 102. For example, the client may utilize the client device to parse through the trace tree data to find a problematic trace.

At block 354, the client instance 102 may receive an input to filter a portion of the trace tree data. The input may arrive from block 374, where the user may utilize a client device 20 to initiate a request to filter a portion of the trace tree data. The client instance 102 may then receive the request from the client device 20. In some embodiments, the input may specify that the filter to remove all back-end traces (e.g., traces that involve back-end devices/components) from the trace tree. This may be advantageous when the problematic trace is likely a front-end trace (e.g., a trace that involves front-end devices/components). Conversely, in other embodiments, the input may specify that the filter to remove all front-end traces. This may be advantageous when the problematic trace is likely a back-end trace. In yet other embodiments, the input may specify that the filter trim the trace tree. This filter option may not remove all front-end traces or all back-end traces, but rather it may trim the trace tree data to include only primary traces (e.g., according to a set of rules/conditions), a simplified view of the traces, traces with a threshold number of branches, or a combination thereof.

At block 356, an application server or processor-based device of the client instance 102 may filter the trace data based on the input to generate filtered trace data. As discussed, above, the filters may include filtering out front-end data, filtering out back-end data, or trimming the trace tree. The user may select a relevant filter for the user's situation. In some embodiments, the user may select one of the preset filters described above. In other embodiments, the user may create their own filter based on what traces the user wishes to see. This may be advantageous when the preset filters do not provide all the traces the user wishes to see in one or more instances.

At block 376, the client device 20 may receive via the client instance 102 the filtered trace data based on the input prompting generation of the filtered trace data. As stated above, the trace data received by the client device 20 is based on the filter parameters used to filter the trace data.

At block 358, an application server or processor-based device of the client instance 102 may generate or otherwise cause the generation and display of a graphical representation that includes a trace tree having the subset of the plurality of traces. For example, the graphical representation may display the nested nature of the traces, with one or more traces nested inside another trace. Nested traces group multiple requests or commands together to show how the traces relate to each other. Specifically, a trace illustrates the entire route a request takes. If multiple requests or commands are made within another command or request, the child command or request may appear as a nested trace of the parent command or request. This may organize the commands and requests in an easy to trace way, illustrating what steps (e.g., commands, requests, queries, etc.) were required to make each request or command happen. Nested traces may provide visual indications of workflow bottlenecks and provide for simpler visualization of workflows. Accordingly, the disclosed techniques drastically decrease the amount of time a user spends opening and compressing nested traces searching for the problematic traces, thus reducing time and resources spent interacting with irrelevant traces. Trace nesting may occur even after the client instance filters the traces. For example, the filter may filter out all back-end traces, leaving only front-end traces. Within the front-end traces remaining, there may be nested traces.

At block 378, the client device 20 may display the graphical representation that indicates a trace tree including the subset of the plurality of traces. The client device 20 may receive the graphical representation generated by the client instance 102 at block 358. The client device 20 may then display the graphical representation for the user to view and manipulate. The graphical representation may be simpler to view and parse than the display of the trace tree data in block 372. For example, instead of having hundreds or even thousands of nested traces for the user to parse, the graphical representation may only display nested traces from the front-end traces.

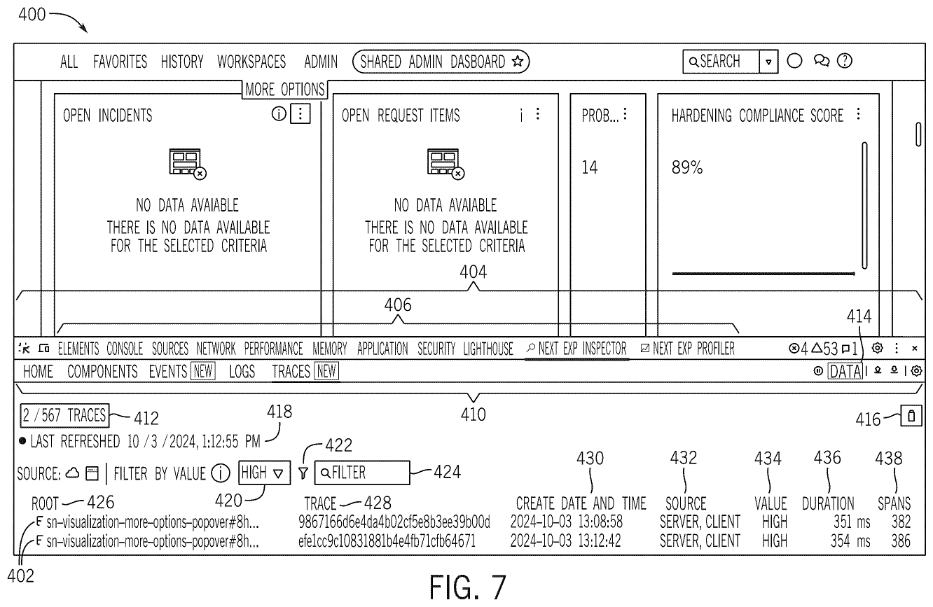

FIG. 7 is a screenshot of a Graphical User Interface (GUI) 400, accessible via a browser, that lists trace trees 402. On the GUI, the user may open the dashboard 404. The dashboard 404 may be expanded to a full-screen view. It may also be closed via a designated button. Further, the dashboard 404 may have a settings feature, which may provide the user with ways to customize the dashboard 404 or its operation. At the top of the depicted example dashboard 404 is a row of widgets, which may display, for example, open incidents, open requests, one or more calculated scores or key performance indicators (KPIs), and so forth. The row of widgets may be customizable by the user. Below the widgets is a toolbar that includes a row of options 406, shown as tabs. Selecting an option 406 may open a tool or set of tools on the dashboard 404, such as ways to view or solve various problems associated with that tool. The row of options 406 may include, for example, Elements, Console, Sources, Network, Performance, Memory, Application, Security, Lighthouse, Next Exp Inspector, Next Exp Profiler, or a combination thereof. However, it should be understood that the options shown in FIG. 7 are merely examples and that other embodiments are envisaged that may include additional, fewer, or different options.

The dashboard 404 may also include an alerts window 408. The alerts window 408 may display warning notifications, alert notifications, and message notifications. These notifications may list how many of each notification there are. The alerts window 408 may also separate the kinds of notifications (e.g., warning, alert, message) or keep the different kinds of notifications separate.

The dashboard 404 may have a menu bar 410 as well. The menu bar 410 may include different aspects of a workflow. The menu bar 410 may have a data link 414 to view the data associated with a workflow. In some embodiments, the data associated with a workflow may include trace data. In other embodiments, the data associated with a workflow may include timestamp data associated with each action in a workflow. The menu bar 410 may include a link to the dashboard 404 home, components, events, logs, and traces. Selection of the link to view the traces may open a list of trace trees 402 on the dashboard 404. In the illustrated embodiment, the traces appear as a list of different trace trees. In other embodiments, the traces may not be displayed as a trace tree 402.

The trace page may also include a trace counter 412. The trace counter 412 may indicate how many trace trees 402 of all the trace trees 402 are shown on the trace page at one time. The trace page may also include a data link 414, which, upon selection, may cause the data used to create the trace trees 402 to be displayed. This may be advantageous by providing the user with a way to see where relevant data may be, why the trace trees 402 formed the way they did, and the like.

The dashboard may also have a deletion option 416. The deletion option may provide a method for the user to dispose of unwanted or unhelpful traces. This may be technologically advantageous by limiting the amount of trace data the database 300 needs to maintain.

The trace page may also include a refreshment notice 418. The refreshment notice 418 may provide a timestamp indicating when the system last updated the trace trees 402. In some embodiments, the time stamp and corresponding traces may automatically update when a new trace or trace tree 402 is available. In other embodiments, the time stamp and corresponding traces may only update if the user refreshes the page. Any updates, either automatic or manual, may be reflected in the refreshment notice 418.

The trace page may include a value filter 420. The value filter 420 may have preset options such as high value or low value. In some embodiments, the value filter 420 may provide the user with the ability to manually create the user's own value filters. In some embodiments, the value filter may filter by the quality of the trace or trace tree 402. The value of a trace or trace tree 402 may be based on likelihood of importance, amount of data involved in creation of the trace or trace tree 402, and the like. In other embodiments, the value filter may filter by alphabetical or numerical order.

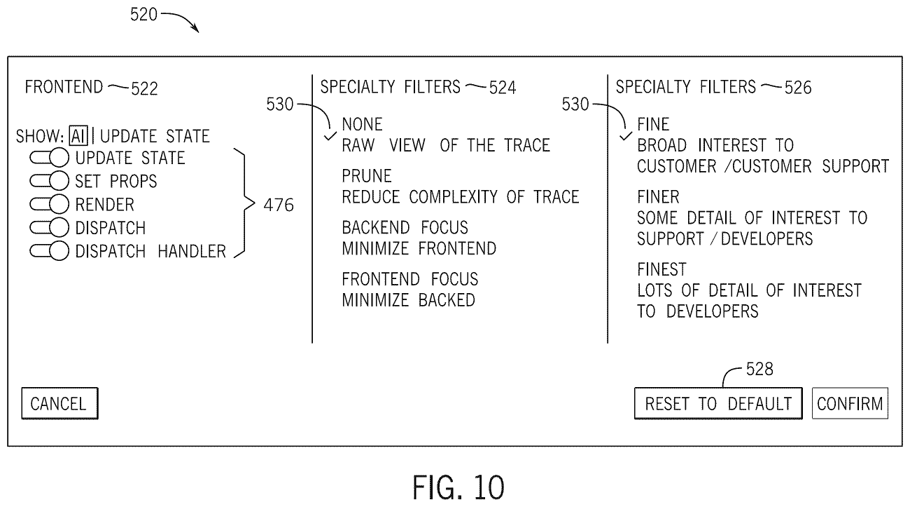

The trace page may additionally have an option to configure and/or apply a filter 422. The filter 422 may have multiple preset filter options, or may provide ways for users to create their own filters based on the user's application. The filters are discussed more in relation to the detailed description for FIG. 10.

The filter 422 may have a filter search bar 424. The filter search bar 424 may allow the user to search for a preset or manually created filter to apply. The filter 422 may appear in a drop-down menu from the filter search bar 424 for the user to select. In some embodiments, filter options may appear in the drop-down menu of the filter search bar 424 based on user input to the filter search bar 242. In other embodiments, when the user input does not match any filter options, the filter search bar drop-down menu may list potential filters 422 based on the most similar available filters 422 to the user input.

The trace page may also list details about trace trees 402 in a table including the trace root 426, trace name 428, date and time of creation 430, trace source 432, value 434, trace duration 436, trace spans 438, and the like. The root column may list the name of the root 426 of the trace tree 402. The root 426 may be selectable, and may expand to display the entire trace tree when selected. The trace name column may list the trace name 428 for the respective trace tree 402. The trace name may be auto generated. However, in some embodiments, the user may rename trace trees for ease of locating, as a recognizable word or name may be simpler to locate than a string of numbers and letters. The date and time of creation column may display the date and time the trace tree 402 was created. The date and time of creation 430 may list the date and time with a target level of specificity. For example, a user may not need the system to display the millisecond at which a trace tree 402 was created, as there may not be trace trees obtained more than once a minute or second. Limiting the specificity of the date and time of creation may reduce computing power. The source column may display the source 432 of the trace tree 402. The source may specify whether the trace tree 402 is rooted in the client's side or the instance's side. Further, the source 432 may also specify if the source of the trace tree 402 includes the server.

The trace page may also include and display a value 434 for each trace tree 402. The value 434 may be a high, a low, or a value manually created by the user. The value 434 may inform the user of the value 434 of the corresponding trace tree 402. For example, the user may only want to look through high value trace trees 402. The value column provides a clear way of determining which trace trees 402 are high value and which trace trees 402 are low value. The trace page may also include a duration column, which may list the duration 436 of each trace tree 402. The duration 436 may be as long as the workflow associated with the trace tree 402 took to complete. The trace page may also list the spans 438 associated with a trace tree 402, where the spans 438 are the number of traces the trace tree 402 spans.

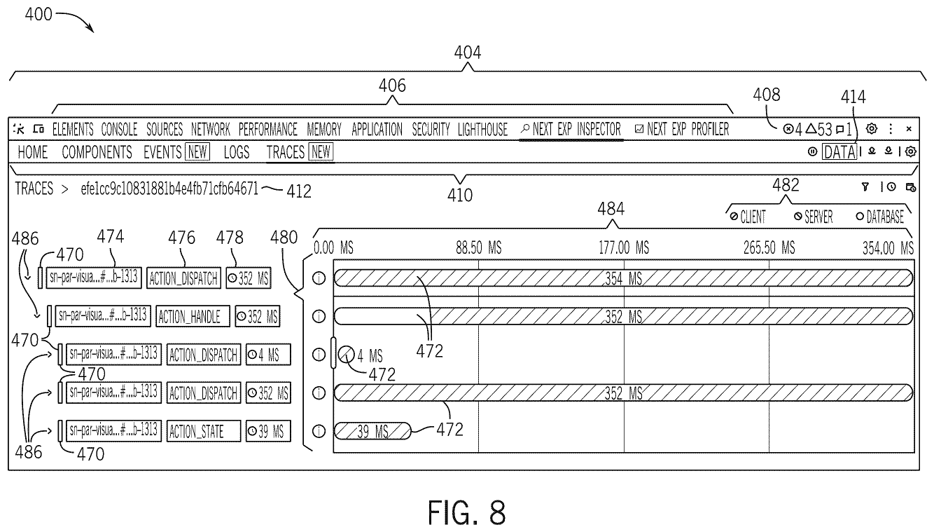

FIG. 8 is a screenshot of a GUI 400 that illustrates the expandability of the trace tree 402. On the dashboard 404, within the “Next Exp Inspector” option of the menu of options 406 and the trace page, if a user selects a trace tree 402 by selecting its trace name 428 or root 426, the trace tree 402 may expand to display the traces 500 within the trace tree 402. In some embodiments, the GUI 400 may display all of the trace branches 470 within a trace tree 402. This may be advantageous by limiting how many trace branches may be opened to display the problem trace. In other embodiments, the GUI 400 may display only the first level of trace branches 470. This may be advantageous by limiting the amount of visual clutter on the screen, which may make it simpler and more efficient for the user to navigate to the correct trace branch 470 to open in search for the correct trace. Each trace branch 470 may have a drop-down arrow 486, which the user may select to reveal any further trace branches 470 or traces within the next inner level of a trace branch 470. Once a trace branch 470 arrives at the inner-most trace, there may not be a drop-down arrow for the user to select. Each trace branch 470 may list a root name 474, REST API application item 476 associated with each trace branch 470, and a length of time 478 the workflow associated with each trace branch 470 lasted.

The length of time 478 the workflow associated with each trace branch lasted may be visually represented through a time graph 484. The time graph 484 may include a scale of the number of milliseconds a trace branch may last. The length of time 478 the workflow associated with each trace branch 470 lasted may be represented via a corresponding line 472 on the time graph 484 which may extend from the beginning of the workflow to the end of the workflow associated with each trace branch 470. The line may represent the amount of time a workflow associated with every trace within the trace branch 470 lasted. The GUI 400 may also include a key 482 which may identify colors, line type, or the like associated with the trace branch 470, as represented by the corresponding line 472 on the time graph 484, and/or the colored bar beside each root name 474. The key may identify trace branches 470 associated with client workflows, server workflows, database workflows, and the like. Each trace branch 470 may also have a corresponding information button 480. The information button 480 may provide information about the respective trace branch 470, such as the number of traces within the trace branch 470, the trace branch root 426, the start time of each trace branch 470, and the like.

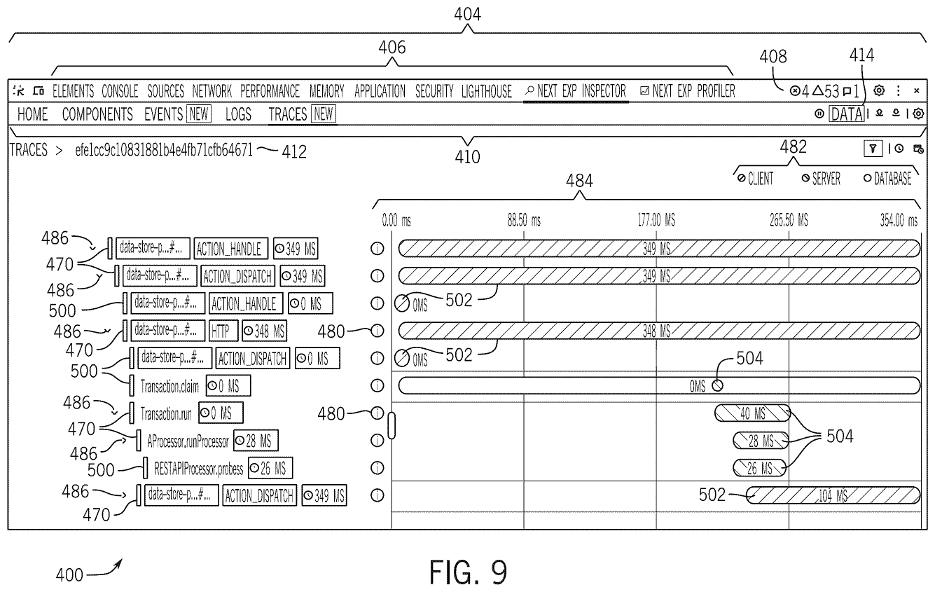

FIG. 9 is a screenshot of a GUI 400, accessible via a client device, that illustrates the front-to-back-end nature of trace trees 402. Within each trace branch 470 may be one or more traces 500 or additional nested trace branches 470. Traces 500 may not have a drop-down arrow 486 beside the trace in the trace tree listing, as traces 500 are the innermost parts of a trace tree 402. In some embodiments, the traces 500 may be considered the leaves of the trace tree. As discussed above, the key 482 may list the origin of the trace (e.g., client-side, server-side, database, etc.). Client-side traces or trace branches are front-end traces or trace branches 502. Conversely, server-side traces or trace branches and data center traces or trace branches are back-end traces or trace branches 504. As depicted in the illustrated embodiment, back-end traces or trace branches 504 may be stored within a trace tree 402 that includes only front-end trace trees or trace branches 502. In some embodiments, a trace branch 470 may contain only front-end branches or traces 502 or only back-end branches or traces 504 from the outermost trace branch 470 to the innermost trace 500. In other embodiments, the trace branch 470 may contain a combination of front-end branches or traces 502 and back-end branches or traces 504.

Further, it should be noted that not all traces 500 or trace branches 470 begin at a time of 0.00 milliseconds (ms). Indeed, as depicted in FIG. 9, some traces 500 or trace branches 470 may begin partway through a workflow, and, as a result, may have a start time of any point between 0.00 ms and the end time of its respective workflow.

Additionally, for back-end traces or trace branches 504, the root name 474 may instead be the name of a segment of code run on the server during that trace of the workflow, or the name of data from the data center. This may be beneficial by providing an efficient reference to the user to inform the user what code was running during a specific back-end trace or trace branch 504, which may alert the user to a problem with that back-end trace or trace branch 504 or its corresponding code.

With the foregoing in mind, FIG. 10 is a screenshot of pop-up window 520 that may appear on the GUI 400, accessible via a client device, that illustrates the filter options for filtering the trace tree 402. When a user selects the filter 422, the filter block may appear on the display of the GUI 400. The filter pop up window 520 may include a front-end filter section 522, a specialty filters section 524, and a filter levels section 526. The filter pop up may also have a reset button 528. In some embodiments, the reset button 528 may remove all filters from the system. In other embodiments, the reset button 528 may reset the filters to a preselected default filter. This may be advantageous when the user regularly uses filters.

The front-end filter section 522 may provide the user with filter options to select what front-end traces or trace branches 502 are displayed. The front-end filter section 522 may provide the user with the choice of displaying or hiding traces 502 and trace branches 470 with REST API application items 476 such as update state, set props, render, dispatch, dispatch handler, and the like. The front-end filter options may include toggle switches for each of the REST API application items 476. The user may use the toggle switches to select which REST API application items 476 are displayed in the trace tree 402. Further, the front-end filter section 522 may include a switch for the GUI 400 to display all REST API application items 476 or no REST API application items 476. Further, it should be noted that, in some embodiments, the REST API application items 476 available for filtering in the front-end filter section 522 may not be all the REST API application items 476 used by the frontend. Instead, the front-end filter section 522 may only include REST API application items 476 the user may regularly filter out.

In the specialty filters section 524 of the filter options, the user may select a focus of the trace tree 402 for the GUI 400 to display. The selected focus may be marked by an indicator 530. The indicator 530 may be a check mark, bold text, underline, circle, or the like. In some embodiments, the specialty filters section 524 may include a prune filter (e.g., a filter which reduces the complexity of the trace tree), a backend focus filter (e.g., a filter which minimizes the frontend traces), a frontend focus (e.g., a filter which minimizes the backend focus), and an option not to filter (e.g., display the raw view of the trace tree).

In other embodiments, the user may create a separate filter designed to filter the trace trees 402 based on targeted traces. For example, if a particular trace 500 regularly has issues, a manually constructed filter may search for the particular parameters of that trace. The parameters may include frontend and backend filtering, REST API application filtering, start time, end time, duration, code title, root, and the like.

The filter may also include a filter levels section 526. The filter levels section may provide a way to filter the trace trees 402 by the amount of detail of the trace trees to display. The filter levels may be fine (e.g., broad interest to customers/customer support), finer (e.g., some detail to customer support/developers), and finest (e.g., a lot of detail of interest to developers). These filters may filter out application or code features, factor in client side and server-side needs, and the like. In some embodiments, the user may create their own filter levels based on filtering targets. For example, if the user had a broad interest in customer support, but also desires detail to a specific aspect of developers, the user may manually create a filter to focus on the things of particular interest to the user.

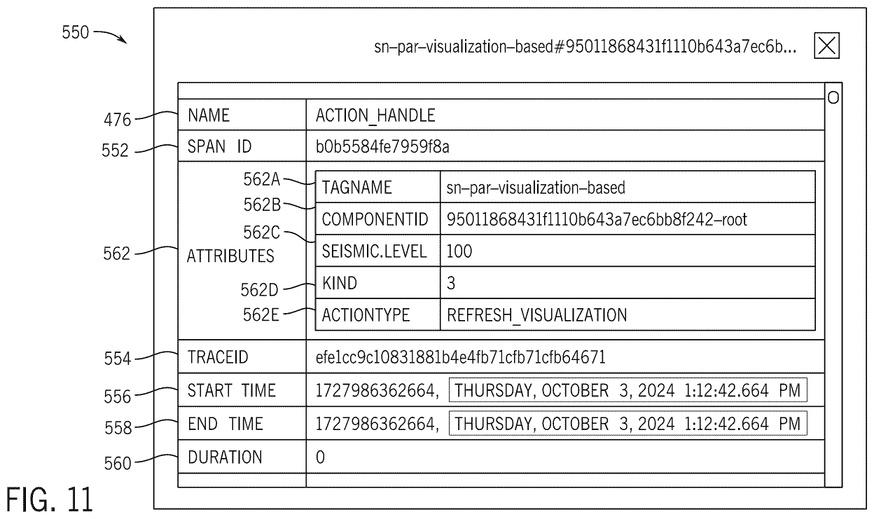

FIG. 11 is a screenshot of an attribute pop up window 550 on the GUI 400, accessible via a client device, that illustrates different viewable attributes of a trace tree 402. The attribute pop up window 550 may list the REST API application item 476, the Span ID 552, the trace ID 554, the start time of the trace 556, end time of the trace 558, the duration of the trace in milliseconds 560, attributes 562 (e.g., the tag name 562A, component ID 562B, seismic level 562C, kind 562D, type of action 562E, etc.), and the like. The attribute pop-up may be opened for any trace 500 on the trace tree 402. Further, the attribute pop-up may include other attributes and information relevant to the user's reasons for searching the trace trees.

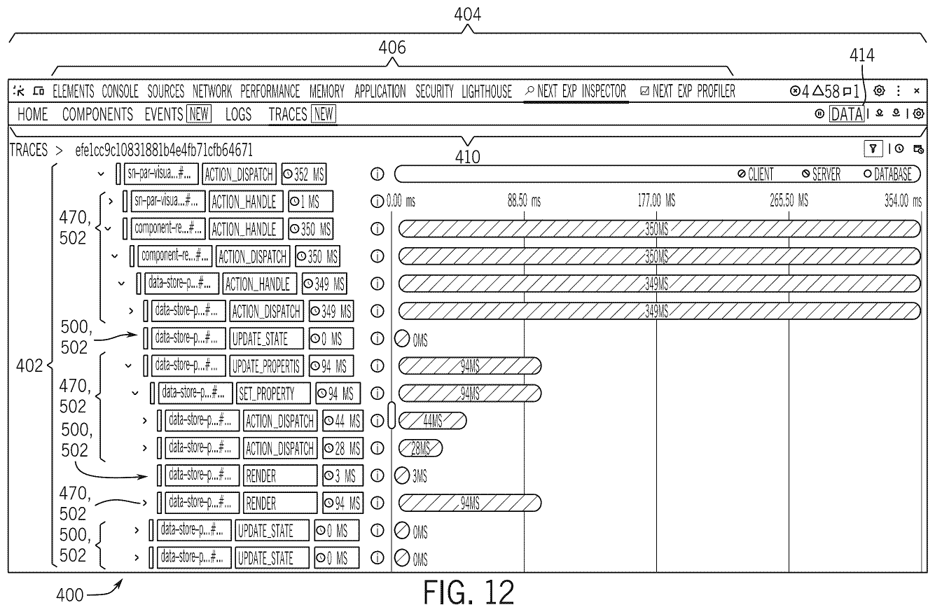

FIG. 12 is a screenshot of a GUI 400, accessible via a client device, that illustrates a partially expanded trace tree 402 before filtering. The trace tree 402 may have hundreds or thousands of traces 500 within it, nested within trace branches 470. As shown in the illustrated embodiment, there may be numerous levels of expanded trace branches 470 to filter through before reaching the innermost trace 500 of a trace branch 470. The nested trace branches 470 may make parsing the trace tree 402 difficult and inefficient. Further, in the illustrated embodiment, all of the traces branches 470 have led to a frontend trace or trace branch 502 In an example where the user is searching for back-end trace or trace branch 504 information, it may be very difficult for the user to determine which trace branch 470 may lead to a back-end trace or trace branch 504, and which trace branches 470 may only lead to a frontend trace or trace branch 502.

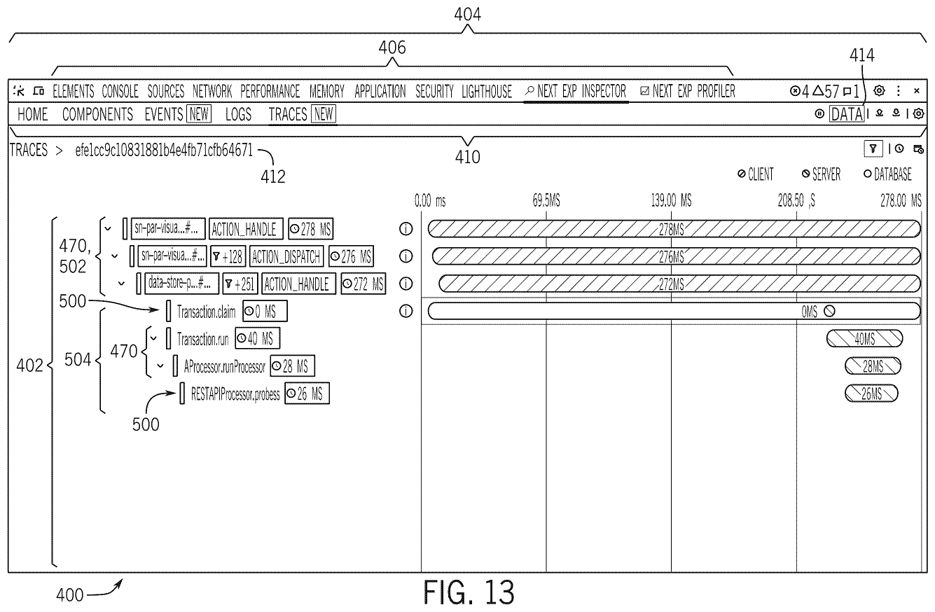

FIG. 13 is a screenshot of a GUI 400, accessible via a client device, that illustrates a filtered trace tree 402. The filtered trace tree 402 may be easier for the user to read and parse than the unfiltered trace tree 402 illustrated in FIG. 12. The illustrated filtered trace tree 402 is more compact than the unfiltered trace tree 402 and may fit on the client device's display better than an unfiltered trace tree 402. In the illustrated embodiment, there is one trace branch 470 for the user to parse, and each nested trace branch 470 only has one trace branch 470 within it. In other embodiments, the filtered trace branches may have more than one trace branch 470 nested within one trace branch 470. However, the filtered trace tree 402 may be simpler and more efficient to parse than an unfiltered trace tree 402 because the filtered trace tree 402 may be more compact and display fewer trace branches 470 that may not be of interest.

Furthermore, in some embodiments, the filtered trace tree 402 and trace branches 470 may include relevant context associated with the selected filters. This may be advantageous by providing a way for the user to view the situation surrounding a problematic trace 500. The context may include the surrounding trace branch or branches 470 helpful in understanding where the problematic trace 500 was within an associated workflow. In some embodiments, context may be based on commonly used surrounding trace branches 470 associated with a particular type of trace (e.g., based on the trace's attributes). In other embodiments, the context may be based on the filter selections. In yet other embodiments, the context may be based on trace branches 470 associated with or nested around a trace 500.

The presently disclosed techniques are directed to generating a UI indicating trace trees of traces obtained during execution of a workflow such that the trace tree can be displayed on a graphical user interface (GUI) while maintaining context of traces in the trace tree. For example, if a workflow has a problem with the back-end development, the algorithm may filter the trace tree to show only back-end traces. These traces may feature some context to assist with understanding the trace causing the workflow issue, such as traces that precede or proceed back-end traces. Further, the algorithm may bypass context determined to be irrelevant (e.g., based on filter settings, display settings, etc.). Conversely, if a workflow has a problem with the front-end development, the algorithm may filter the trace tree to show only front-end traces. Alternatively, the algorithm may prune the trace tree to generally simplify the trace tree to allow the GUI to display the trace tree more efficiently. Pruning may be used to simplify the tree by removing any trace branches (e.g., nodes) that has only a single trace (e.g., single child node) within it. This may limit noise in the system that does not assist in debugging. For example, if root node A has a single child node B, and single child node B itself has a single child node C, pruning would remove single child node B from the trace tree. As another example, in a trace tree as described above, but with an extra root node E and single child node C having a single child node D, pruning would remove single child node B and single child node C, but would leave the root nodes A and E and the single child node D because it does not have a child node. By removing the irrelevant sections of the trace-tree, the sections of the trace tree that are relevant or otherwise useful for understanding the workflow issue may fit better on the GUI and make determining any issues with the workflow less tedious than when the entire trace tree is displayed on the GUI. The algorithm may capture the hierarchies (e.g., nests) of the traces in the trace tree. Further, the algorithm may mark the start and end time of the traces to calculate the duration of the traces.

In another embodiment, the algorithm may utilize a critical path filter. The critical path filter may simplify the trace by maintaining only the path with the highest cumulative execution time. The critical path filter may remove all trace branches except the trace branch that contributes most to the total runtime, which may be advantageous for users searching to quickly find the trace branch with the biggest performance impact. Easy location of the trace branch with the biggest performance impact may assist users in focusing the user's optimization efforts.

In yet another embodiment, the algorithm may filter for trace branches with spans over a threshold time. The filter may traverse the entire trace tree and remove branches where the cumulative execution time is below a configurable threshold. The threshold may be 40 ms, 50 ms, 60 ms, or the like, based on the user's input and the span times of the trace branches. If a trace branch has an execution time below the threshold span time, the algorithm may remove the trace branch from the trace tree. Conversely, if a trace branch has an execution time above the threshold span time, the algorithm may maintain the trace branch on the trace tree. This filter may assist users in determining operations with larger impacts on system performance, as trace branches with larger spans may impact system performance more than trace branches with smaller spans. Filtering for larger spans may highlight areas of a trace tree which may be causing system delays or other performance issues.

Technical effects of the disclosed techniques include more efficient utilization of resources and computing power by reducing the amount of interaction the user has with the system to convey the same amount of information. Specifically, the system more efficiently utilizes its resources by limiting the amount of interaction the user has with the trace tree. The system also reduces system noise by limiting the amount of unnecessary clicking and unhelpful or incomplete summarization.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving trace data indicative of a plurality of traces associated with a workflow;
receiving an input to filter a portion of the trace data;
filtering the trace data based on the input to obtain filtered trace data, wherein the filtered trace data is indicative of a subset of the plurality of traces; and
generating, based on the filtered trace data, a graphical representation that indicates a trace tree including the subset of the plurality of traces.

2. The method of claim 1, wherein the graphical representation comprises one or more elements, the method further comprising, in response to receiving data indicative of a selection of the one or more elements, updating the graphical representation to include contextual trace data.

3. The method of claim 2, wherein the contextual trace data for a particular trace includes trace data within 5 or fewer nested trace nests of the particular trace.

4. The method of claim 1, wherein the trace data indicates, for each trace of the plurality of traces, a start time, an end time, and a duration, wherein the duration of each trace is based on the respective start time and the respective end time.

5. The method of claim 1, wherein the trace data comprises front-end data from one or more client devices.

6. The method of claim 5, comprising:
receiving an additional input to filter front-end traces from the trace tree;
refiltering the trace data to remove the front-end data associated with the front-end traces; and
updating the trace tree based on the refiltered data to remove the front-end traces from the trace tree.

7. The method of claim 1, wherein the trace data comprises back-end data from a data center.

8. The method of claim 7, comprising:
receiving an additional input to filter back-end traces from the trace tree;
refiltering the trace data to remove the back-end data associated with the back-end traces; and
updating the trace tree based on the refiltered data to remove the back-end traces from the trace tree.

9. The method of claim 1, comprising:
receiving an input to expand a trace nest of the trace tree; and
updating the trace tree to expand the trace nest to display one or more traces within the trace tree.

10. The method of claim 1, comprising:
receiving an input to collapse a trace nest of the trace tree; and
updating the trace tree to collapse the trace nest such that no traces within the trace nest are displayed within the trace tree.

11. The method of claim 1, wherein the input to filter a portion of the trace data is based on a parameter of the trace data.

12. A system, comprising:
processing circuitry; and
a memory, accessible by the processing circuitry, and storing instructions that, when executed by the processing circuitry, cause the processing circuitry to implement a client instance, wherein the system or a different processor-based system on the client instance is configured to perform operations comprising:
receiving trace data indicative of a plurality of traces associated with a workflow;
receiving an input to filter a portion of the trace data;
filtering the trace data based on the input to generate filtered trace data, wherein the filtered trace data is indicative of a subset of the plurality of traces; and
causing the generation of a graphical representation, based on the filtered trace data, that indicates a trace tree including the subset of the plurality of traces.

13. The system of claim 12, wherein the trace data comprises front-end data from one or more client devices, and wherein the client instance is further configured to perform operations comprising:
receiving an additional input to filter front-end traces from the trace tree;
refiltering the trace data to remove front-end traces; and
updating the trace tree based on the refiltered data to remove front-end traces from the trace tree.

14. The system of claim 12, wherein the trace data comprises back-end data from a data center, and wherein the client instance is further configured to perform operations comprising:
receiving an additional input to filter back-end traces from the trace tree;
refiltering the trace data to remove the back-end data associated with the back-end traces; and
updating the trace tree based on the refiltered data to remove the back-end traces from the trace tree.

15. The system of claim 12, wherein the graphical representation comprises one or more elements that, when selected, cause the graphical representation to toggle between contextual trace data being displayed on the graphical representation and the contextual trace data not being displayed on the graphical representation.

16. A non-transitory, computer readable medium comprising instructions that, when executed by processing circuitry, cause the processing circuitry to perform operations comprising:
receiving trace data indicative of a plurality of traces associated with a workflow;
receiving an input to filter a portion of the trace data;
filtering the trace data based on the input to generate filtered trace data, wherein the filtered trace data is indicative of a subset of the plurality of traces; and
causing the generation of a graphical representation, based on the filtered trace data that indicates a trace tree including the subset of the plurality of traces.

17. The non-transitory, computer readable medium of claim 16, wherein the input to filter a portion of the trace data is based on a parameter of the trace data.

18. The non-transitory, computer readable medium of claim 16, wherein the graphical representation comprises one or more elements that, when selected, cause the graphical representation to toggle between contextual trace data being displayed on the graphical representation and the contextual trace data not being displayed on the graphical representation.

19. The non-transitory, computer readable medium of claim 16, wherein the trace data comprises front-end data from one or more client devices, and wherein the operations comprise:
receiving an additional input to filter front-end traces from the trace tree;
refiltering the trace data to remove front-end traces; and
updating the trace tree based on the refiltered data to remove front-end traces from the trace tree.

20. The non-transitory, computer readable medium of claim 16, wherein the trace data comprises back-end data from a data center, and wherein the operations comprise:
receiving an additional input to filter back-end traces from the trace tree;
refiltering the trace data to remove the back-end data associated with the back-end traces; and
updating the trace tree based on the refiltered data to remove the back-end traces from the trace tree.
